(19) United States
(12) Patent Application Publication
(10) Pub. No.: US 2008/0074699 A1
(43) Pub. Date: Mar. 27, 2008

(54) Image processing apparatus and image processing method

(75) Inventor: Koji Washio, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/812,791

(22) Filed: Jun. 21, 2007

(30) Foreign Application Priority Data
Sep. 26, 2006 (JP) 2006-261181

(51) Int. Cl. H04N 1/409; H04N 1/403

(52) U.S. Cl. 358/2.99; 358/3.27

(57) ABSTRACT

Disclosed is an image processing apparatus including: a determining section to determine a target picture element and a partner picture element thereof in a subject image to be processed; a smoothing coefficient calculating section to obtain change amounts of picture element values in the target and partner picture elements by smoothing processing; a thinning coefficient calculating section for obtaining change amounts of picture element values in the target and partner picture elements by thinning processing, a picture element value calculating section to calculate picture element values of the target and partner picture elements processed by the smoothing processing and/or the thinning processing based on the change amounts, and to determine an output picture element value of the target picture element based on a sum of the calculated picture element values of the target picture element and partner picture element.

### BACKGROUND

1. Field of the Invention

The present invention relates to an image processing apparatus and an image processing method for subjecting a subject image to smoothing processing or thinning processing.

2. Description of Related Art

An electrophotographic printer has a greater dot gain as compared with a printer using ink, and if characters are printed in the same font by these printers, the characters printed by the electrophotographic printer becomes thicker in some cases. Hence, a technique for previously subjecting an image to image processing to thin a character thickness is utilized. Such image processing is called thinning processing. According to this processing, an edge of an image of a so-called solid character (character or line which is solidly filled with high density color, and this will be called a solid character, hereinafter) is taken, the density level of this edge portion is converted into intermediate gradation level, so that picture element values in an outline of the solid character are uniformly lowered. Consequently, the character becomes thin visually.

As described above, the thinning processing is carried out for a solid character having a density level (picture element value) of substantially the maximum value.

A solid character is subjected to the smoothing processing in addition to the thinning processing in some cases. According to the smoothing processing, a white (minimum density level) or black (maximum density level) picture element at an outline is converted into a picture element of intermediate gradation level by template matching. Consequently, jaggies of characters (phenomenon that an outline portion looks aliasing (not smooth)) can be moderated.

The smoothing processing generally is to convert a binary image into a multilevel image, and this processing was not carried out for a character including the intermediate gradation level in the conventional technique. Examples of characters including the intermediate gradation level are a character which has been subjected to anti-aliasing and a character image which is output in gray font.

There is disclosed a method for carrying out the smoothing processing while carrying out the thinning processing at the same time (see Japanese Patent Laid-open Applications No.H7-334672 and No.2004-236033 for example). According to this method, an oblique line portion is subjected to the smoothing processing using the template matching, and a horizontal portion such as a vertical line and a lateral line is subjected to the thinning processing, thereby adjusting the line thickness. More specifically, a thinning processing template and a smoothing processing template are prepared, and if a template which is matched by the template matching is for the thinning processing, the thinning processing is carried out, and if the template which is matched by the template matching is for the smoothing processing, the smoothing processing is carried out. That is, the processing switches over in accordance with a structure of an image.

In this method, since the template matching is designed such that the smoothing template is matched with the oblique line portion, the oblique line portion is subjected to only the smoothing processing and not the thinning processing.

Japanese Patent Laid-open Application No.H7-334672 also discloses a method in which the smoothing processing and the thinning processing are carried out at the same time by setting a picture element value converted by the smoothing processing to a small value in consideration of the thinning processing. However, if this method is actually carried out, there is a problem that as a thinning degree is increased, the smoothing effect is deteriorated. Even if such a problem does not occur, an outline portion where the template does not match is not thinned, and there is a possibility that only such outline portion has thick line thickness and an image quality is deteriorated.

Concrete explanation will be made with reference to FIGS. 11A to 11F.

FIG. 11A shows an original image of a solid character, especially an edge portion of the solid character. The edge portion is of an oblique line structure close to horizontal. In this case, the best way is to subject the image to the smoothing processing or the thinning processing so that a target image shown in FIG. 11(B) is obtained. That is, it is preferable that a step-like portion is subjected to the smoothing processing to smoothen the line while the line thickness is thinned totally at the same time.

However, when the original image shown in FIG. 11A is subjected to the smoothing processing only, only an area around the step-like portion is converted into the intermediate gradation level, and a result shown in FIG. 11C is obtained. When the original image is subjected to the thinning processing only, the edge portion is uniformly converted into the intermediate gradation level as shown in FIG. 11D. Therefore, if the smoothing processing and the thinning processing are carried out at the same time, it is expected that the step is smoothed and the picture element value of the edge portion is reduced totally like the target image. However, if the smoothing processing and the thinning processing are merely switched in accordance with the image structure as in the above method, a step-like portion remains as shown in FIG. 11E or the step direction is reversed (portion shown with arrows) and image quality id deteriorated in some cases. According to the method given as the improved method in which the picture element value converted at the time of the smoothing processing is set small, the resultant image is improved to some extent as compared with the result shown in FIG. 11E as shown in FIG. 11F, but a portion where a step can not be made small (portion shown with arrow) still appears, and the image is inferior to the target image shown in FIG. 11B in image quality.

### SUMMARY

It is one of objects of the present invention to achieve thinning and smoothening of an image without deteriorating quality of the image.

To achieve at least one of the objects, according to a first aspect of the invention, there is provided an image processing apparatus comprising: a determining section to determine a target picture element and a partner picture element thereof in a subject image to be processed; a smoothing coefficient calculating section to obtain change amounts of picture element values in the target picture element and the partner picture element by subjecting the subject image to smoothing processing; a thinning coefficient calculating section for obtaining change amounts of picture element values in the target picture element and the partner picture element by subjecting the subject image to thinning processing; and a picture element value calculating section to calculate picture element values of the target picture element and the partner picture element processed by the smoothing processing and/or the thinning processing based on the change amounts of the picture element values by the smoothing processing and the change amounts of the picture element values by the thinning processing, and to determine an output picture element value of the target picture element processed by the smoothing processing and/or the thinning processing based on a sum of the calculated picture element values of the target picture element and partner picture element.

According to a second aspect of the invention, there is provided an image processing method comprising the steps of: a determining step to determine a target picture element and a partner picture element thereof in a subject image to be processed; a smoothing coefficient calculating step to obtain change amounts of picture element values in the target picture element and the partner picture element by subjecting the subject image to smoothing processing; a thinning coefficient calculating step for obtaining a change amounts of picture element values in the target picture element and the partner picture element by subjecting the subject image to thinning processing; and a picture element value calculating step to calculate picture element values of the target picture element and the partner picture element processed by the smoothing processing and/or the thinning processing based on the change amount of the picture element value by the smoothing processing and the change amount of the picture element value by the thinning processing, and to determine an output picture element value of the target picture element processed by the smoothing processing and/or the thinning processing based on a sum of the calculated picture element values of the target picture element and partner picture element.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a diagram showing a functional structure of an image processing apparatus of an embodiment;

FIG. 2 is a diagram showing one example of a template;

FIG. 3 is a diagram showing contents of header information of the template;

FIG. 4 is a diagram showing determining condition of template matching;

FIG. 5 is a diagram showing templates of solid 1 and solid 2;

FIG. 6 is a diagram showing a determining step for determining whether a solid character or not;

FIG. 7 is a diagram showing a determining condition whether smoothing processing should be executed;

FIG. 8 is an explanatory flowchart of a calculation method of a picture element value;

FIG. 9A is a diagram showing a portion of a solid character to be processed;

FIG. 9B is a diagram showing processing procedure of thinning processing or smoothing processing carried out by the image processing apparatus with respect to the solid character shown in FIG. 9A;

FIG. 9C is a diagram showing a result of processing through the processing procedure shown in FIG. 9B;

FIG. 10A is a diagram showing a portion of an image of a solid character to be processed;

FIG. 10B is a diagram showing a processing image when the image shown in FIG. 10A is subjected to only the thinning processing;

FIG. 10C is a diagram showing a processing image when the image shown in FIG. 10A is subjected to only the smoothing processing;

FIG. 10D is a diagram showing a processed image when an output value is set small when the image shown in FIG. 10A is subjected to the smoothing processing;

FIG. 10E is a diagram showing a processing image when the thinning processing and the smoothing processing of the invention are applied;

FIG. 11A is a diagram showing a portion of an image of a solid character to be processed;

FIG. 11B is a diagram showing a target processed image;

FIG. 11C is a diagram showing a processed image when the image shown in FIG. 11A is subjected to the smoothing processing only;

FIG. 11D is a diagram showing a processed image when the image shown in FIG. 11A is subjected to the thinning processing only;

FIG. 11E is a diagram showing a processed image obtained by a method for partially switching between the smoothing processing and the thinning processing; and

FIG. 11F is a diagram showing a processed image obtained by a method for setting an output value small in the smoothing processing.

### DETAILED DESCRIPTION OF PREFERRED EMBODIMENTS

Embodiments of an image processing apparatus and an image processing method according to the invention will be explained with reference to the drawings.

First, a structure will be explained.

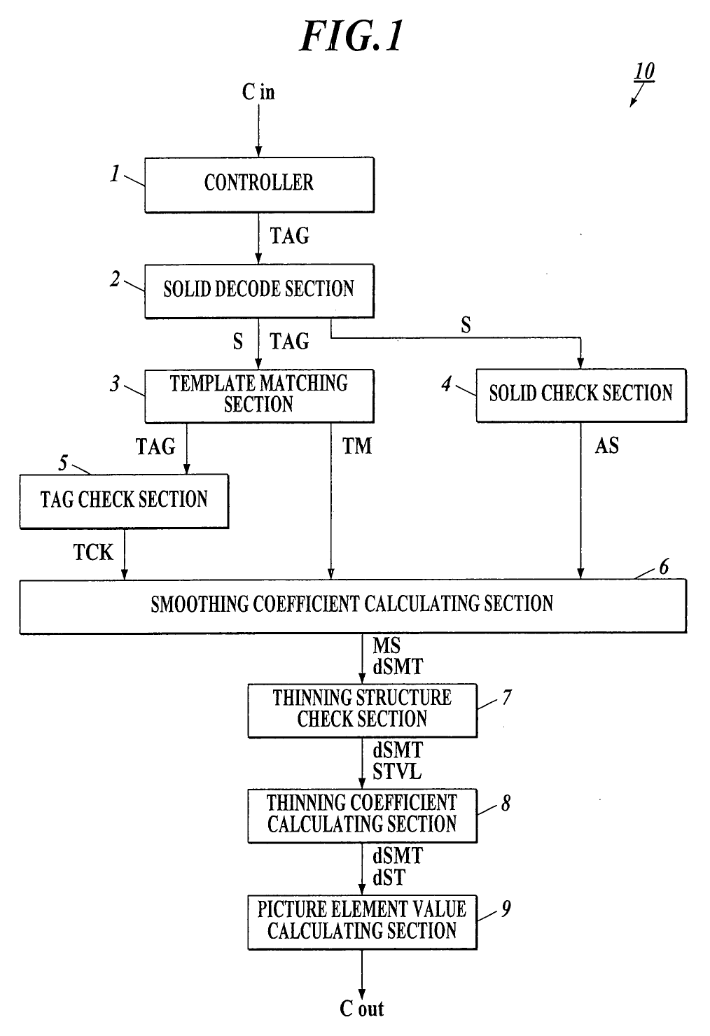

FIG. 1 shows a functional structure of an image processing apparatus 10 of an embodiment.

Here, an example in which the image processing apparatus 10 is incorporated in a printer, image data is produced from PDL (Page Description Language) data which is input into the printer in the image processing apparatus 10, and image processing is carried out will be explained.

As shown in FIG. 1, the image processing apparatus 10 includes a controller 1, a solid decode section 2, a template matching section 3, a solid check section 4, a TAG check section 5, a smoothing coefficient calculating section 6, a thinning structure check section 7, a thinning coefficient calculating section 8 and a picture element value calculating section 9. Parameters and data used for processing in the elements 1 to 9 are stored in a memory (not shown), the elements 1 to 9 read data from the memory when necessary, and the elements use the data for processing.

If PDL data is input, the controller 1 analyzes a PDL command included in the PDL data, the controller 1 classifies the command into an image unit (called object) to be displayed, and forms a display list. The display list is intermediate data in which position coordinates of an object to be displayed address information of region data or color data are described.

The controller 1 produces image data for each of colors, i.e., C (cyan), M (magenta), Y (yellow) and K (black) which can be used by the printer based on the prepared display list. In the image data, picture elements of an object to be displayed based on the display list are allocated, and a picture element value is set for each allocated picture element. In this embodiment, image data in which eight bits, i.e., picture element values of 0 to 255 can be set is produced. The controller 1 discriminates image attribute for each picture element based on the display list, and produces attribute data TAG as a discrimination result. The attribute data TAG is produced in a unit of the picture element, and is classified into TEXT (TAG=0) indicating that a picture element is a character, GRAPHICS (TAG=1) indicating that the picture element is a line, and IMAGE (TAG =2) indicating that the picture element is a photograph.

The controller 1 outputs the produced image data of each color to the solid decode section 2 together with the attribute data TAG.

The solid decode section 2 produces solid data S for each picture element based on image data which is input from the controller 1. The solid data S is a result obtained by roughly determining whether a picture element constitutes a solid character. The solid decode section 2 produces solid data S using two threshold values SOA and SOB. That is, if the picture element value is within a range of 0 to SOA, it is determined that a possibility of a solid character is low and S is set to 1 (S=1), and if the picture element value is within a range of SOB to 255, it is determined that the possibility of the solid character is high and S is set to 2 (S=2). If the picture element value is in a range of (SOA+1) to (SOB−1), it is determined that the possibility is not high or low, and S is set to 0 (S=0).

The solid decode section 2 outputs the produced solid data S to the template matching section 3 and the solid check section 4.

The template matching section 3 matches 128 templates and solid data S in an image region where there is an input image with each other, and detects a structure which should be subjected to the smoothing processing or a structure which should be subjected to the thinning processing. The structure which should be subjected to the smoothing processing is a structure which is an edge portion of an object of a character or a line and which includes a step-like portion. The structure which should be subjected to the thinning processing is an edge portion of a solid character. This matching operation is carried out so that a target picture element is set for an input image, and a position of the target picture element and a position of a target picture element which is preset in the template are matched with each other. By sequentially setting the target picture elements for all of the picture elements of input image, template matching for all of regions of the input image is carried out.

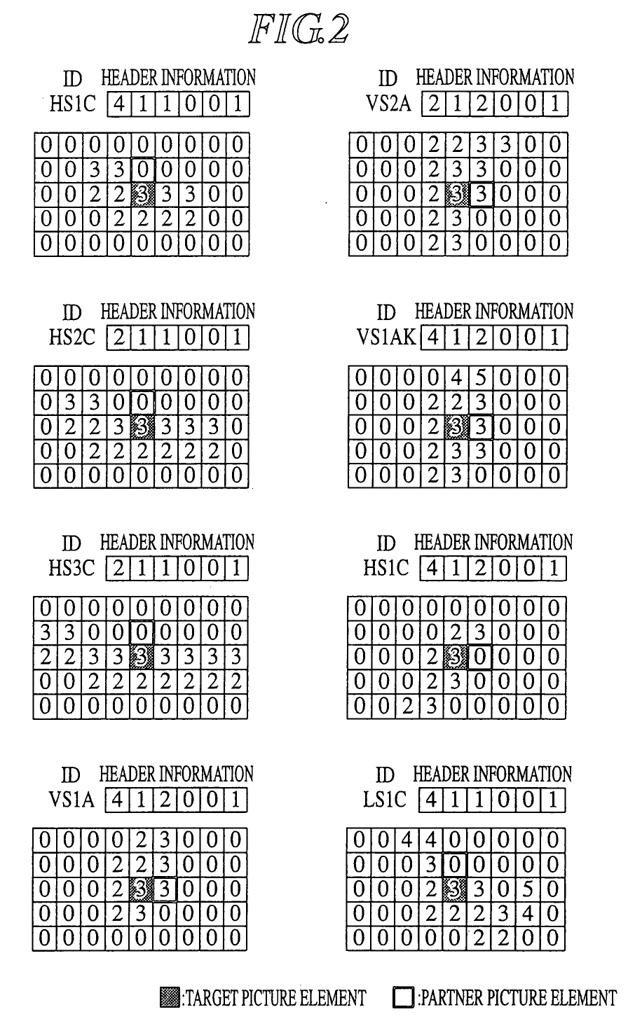

FIG. 2 shows a portion of the template.

As shown in FIG. 2, in the template, template data T (number indicated in each picture element in FIG. 2) is set for 5×9=45 picture elements. The template data T is a value from 0 to 6. A center picture element (colored picture element in FIG. 2) of the template is predetermined as a position of a target picture element. A picture element surrounded by a thick line is a picture element which should be a partner picture element of the target picture element in the template. The partner picture element is adjacent to the target picture element, and is subjected to the smoothing processing and/or the thinning processing integrally with the target picture element. A position of the partner picture element is previously set in the template in accordance with a structure which should be subjected to the smoothing processing to be detected by the template and a structure to be subjected to the thinning processing.

In the template, a change amount of the picture element value by the smoothing processing, and a changing directional property (symbol of increase and decrease) in addition to the position of the partner picture element are preset, and a picture element and a shift picture element (which will be described later) of the target picture elements or the partner picture elements which should be subjected to the smoothing processing and/or the thinning processing are designated. They are determined in accordance with a positional relation between the target picture element and the partner picture element determined by the template in addition to a structure to be subjected to the smoothing processing and a structure to be subjected to the thinning processing to be detected by the template.

The setting is added to each template as the header information. Six numbers indicating the setting items in association with addresses from 0 to 5 are accommodated in the header information. In FIG. 2, a symbol “HS1C” shown on the left side of the header information is an ID for identifying each template.

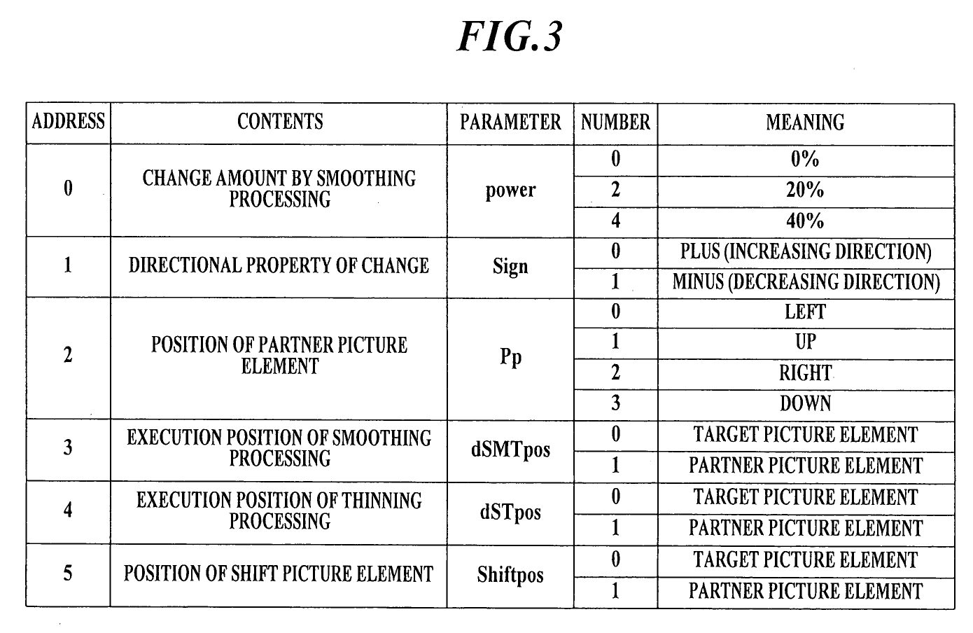

Meanings of numbers in each address are as shown in FIG. 3. That is, a number indicating a change amount power of a picture element value by the smoothing processing is stored in address 0. Number 0 indicates that power=0, number 2 indicates that power=20, and number 4 indicates that power=40. The power shows a ratio of variation with respect to the maximum picture element value. Since the maximum picture element value is 255, when power=20 (%), the change amount (changing picture element value) is 255×0.2. A number indicating directional property whether a picture element value is increased or decreased by the change amount power is stored in the address 1. Number 0 indicates plus, i.e., that a picture element value is increased, number 1 indicates minus, i.e., that the picture element value is decreased. Number indicating a position of the partner picture element based on a position of the target picture element is stored in address 2. The numbers 0, 1, 2 and 3 respectively indicate left, up, right and down. In FIG. 2, positions shown with these numbers are shown as positions of the partner picture element with thick frames.

Numbers showing whether a picture element to be subjected to the smoothing processing or thinning processing is a target picture element or a partner picture element are stored in address 3 and address 4. Number 0 indicates a target picture element, and number 1 indicates a partner picture element. Number indicating a position of a shift picture element is stored in address 5. The shift picture element is a picture element to be shifted when a picture element value exceeding the range of 0 to 255 by the smoothing processing and/or the thinning processing in the target picture element or the partner picture element is shifted to the partner picture element or the target picture element, i.e., the exceeding picture element value is compensated. Number 0 indicates that the shift picture element is a target picture element, and number 1 indicates the shift picture element is a partner picture element.

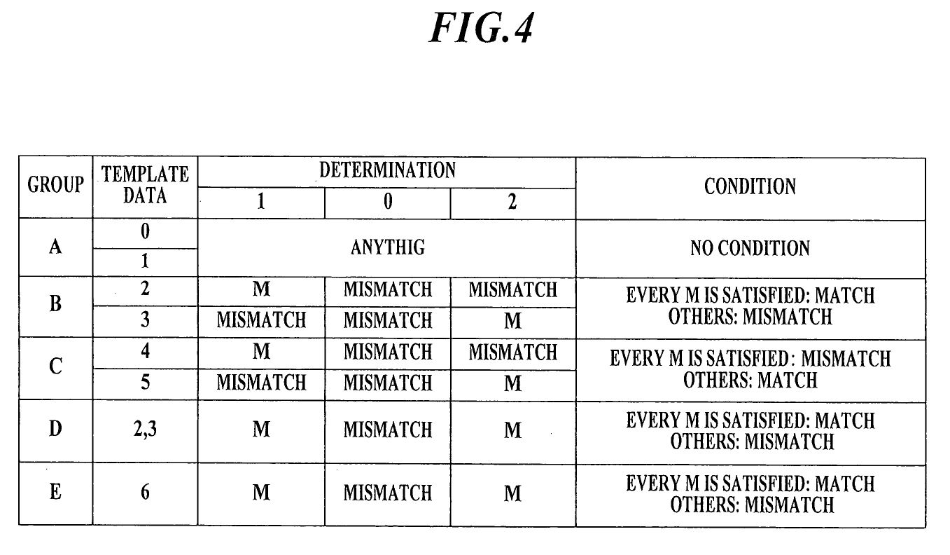

It is determined whether template matches in accordance with determination criterion as shown in FIG. 4. In the determination criterion shown in FIG. 4, two sets of template data T values 0 to 6 are combined and classified into four groups A to E, and the determining condition is defined for each group. In group A, a determining condition for template data T values 0 and 1 are defined. Under the determining condition, it is determined that the template matches even when solid data S of the picture elements located in the positions of template data T values 0 and 1 is any of 1, 0 and 2. Group B is a determining condition concerning template data T values 2 and 3, and it is determined that the template matches when the template data T value has a value of solid data S in which all of picture elements located at the position 2 are 1 and the template data T value has a solid data S value in which all of picture elements located at the position 3 have the solid data S value 2.

Group C of a group of template data T values 4 and 5, and it is determined that the template matches when all of solid data S values of picture elements where the template data T value is located at position 4 are 1, and the template data T and all of solid data values of picture elements located at position 5 are 2.

As can be seen from the determining condition and the example of templates, the template data T is set such that the template matches with an image region having a structure to be subjected to the smoothing processing and/or the thinning processing (edge portion of a solid character having a picture element value of SOB or higher and at which the edge constitutes a step). For example, in the template of IMAGE DATA “HS1C” in FIG. 2, a picture element in which T is 3 matches when solid data S becomes 2, and a picture element in which T is 2 matches when solid data S becomes 1. That is, it is possible to detect a picture element group of T=3 where an edge portion of a solid character and a step are constituted, and a picture element group of T=2 constituting a low density background.

Groups D and E are determining conditions used for the later-described solid check section 4. The group D determines that template matches only when all of picture elements corresponding to the template data T values 2 and 3 are 1 or 2. The group E is a group of template data T value 6, and it is determined that template matches only when a picture element of the template data T is a solid data S value 1 or 2.

Here, 32 basic templates in which some basic structures to be detected are assumed are prepared, derivative templates in which the basic templates are arranged vertically symmetrically, laterally symmetrically and diagonally symmetrically, and 128 templates are prepared in total.

Procedure of the template matching using the determining condition shown in FIG. 4 will be explained.

First, in the template matching section 3, an image region corresponding to a template (image region of 45 picture elements) is extracted from an input image to be processed based on a position of a target picture element, template data T of the template and solid data S of the extracted image region are matched, and it is determined whether they match with each other for each group in accordance with the determining condition. For the group A for example, solid data S values of picture elements corresponding to the template data T values 0 and 1 are referred to, and it is determined whether the determining condition is satisfied. This operation is carried out for each of the groups A to D.

If all of results of determinations in the groups A to D are “matched”, it is finally determined that the matched template and the extracted image region are matched.

The above-described determination is carried out for all of 128 templates. If there is a template determined as matched, matching data TM indicative of matching result is set to 1. The matching data TM is output to the smoothing coefficient calculating section 6. If there are a plurality of templates determined as matched, one of them is specified as a representative template based on a predetermined priority. Here, the matching order of templates is defined as the priority. In the later processing, a partner picture element is a picture element located at a position determined as a partner picture element by the representative template.

When no template is determined as matched, TM is set to 0, and this is output to the smoothing coefficient calculating section 6.

Next, processing of the solid check section 4 will be explained.

The solid check section 4 checks whether an image region where the template matching is carried out constitutes a solid character simultaneously with the processing in the template matching section 3. Since the template is designed based on some structure to be detected previously, even when it does not match the template, it is conceived that a solid character is constituted in some cases. Here, such an image region is detected.

More specifically, in the template matching, it is determined whether a solid data S value of picture elements corresponding to the template data T values 2 and 3 is 1 or 2 in accordance with the determining condition of the group D shown in FIG. 4. When the solid data S value is 1 or 2, it is determined that the solid character is constituted, and otherwise, it is determined that the solid character is not constituted.

Alternatively, checking is carried out using a template shown in FIG. 5 in accordance with the determining condition of the group E shown in FIG. 4. Templates of the solid 1 and the solid 2 shown in FIG. 5 is for checking that a picture element of an intermediate level is not included in an image region where the template matching was carried out. The solid check section 4 matches templates of the solid 1 and the solid 2 with respect to a region where the template matching was carried out in the template matching section 3, and when a solid data S value of a picture element corresponding to the template data T value 6 is 1 or 2, it is determined that it matches with the templates of the solid 1 and solid 2. That is, it is determined that an image region where the template matching was carried out constitutes a solid character.

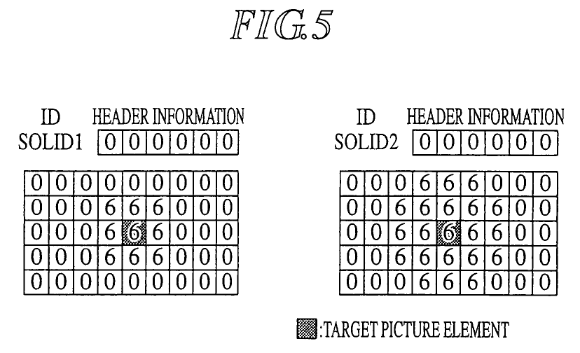

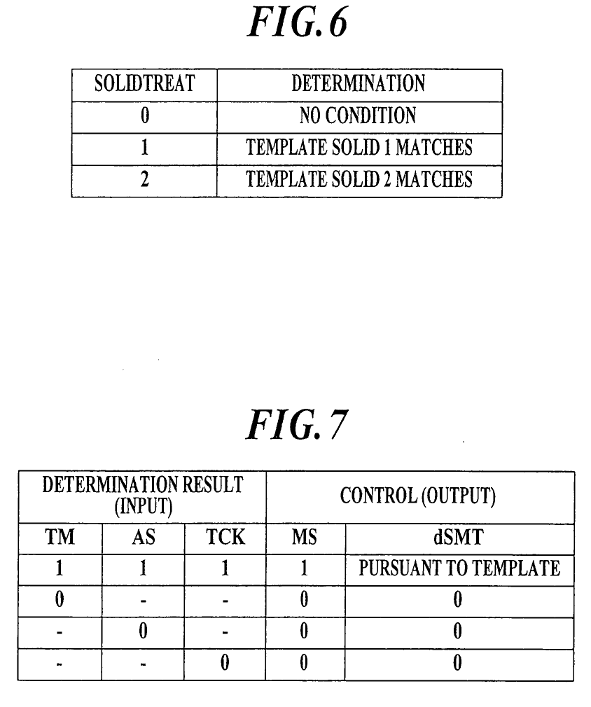

Templates of the solid 1 and solid 2 are designed such that region ranges where it is determined whether template matches are different (solid 1<solid 2). With this, it is possible to stepwisely determine whether it is a solid character or not. This selects a step for determining whether it is a solid character by setting a parameter value called SOLIDTREAT. A corresponding relation between a set value of the SOLIDTREAT and a determination step is shown in FIG. 6. As shown in FIG. 6, when SOLIDTREAT is 0, it is determined that an image region where template matching was carried out constitutes a solid character. When SOLIDTREAT is 1, it is determined that a solid character is constituted only when the template of the solid 1 matches, and it is determined that a solid character is constituted only when the template of the solid 2 matches if SOLIDTREAT is 2.

When it is determined that a solid character is constituted, the solid check section 4 sets check data AS to 1. The check data shows a result of the check. When it is determined that a solid character is not constituted, AS is set to 0, and the check data AS is output to the smoothing coefficient calculating section 6.

The TAG check section 5 detects attributes of images for the target picture element and the partner picture element. That is, attribute data TAG of the target picture element and the partner picture element is referred to, and when TAG is 0 or 1 (when the picture element constitutes a character or a line), check data TCK showing a result of the check is set to 1. When TAG is 2 (when the picture element constitutes a photograph), TCK is set to 0, and the check data TCK is output to the smoothing coefficient calculating section 6. In the representative template, this partner picture element is a picture element at a position which is defined as a partner picture element.

The smoothing coefficient calculating section 6 determines whether a target picture element is subjected to the smoothing processing based on the matching data TM, the check data AS and TCK. When it is determined that the target picture element is subjected to the smoothing processing, the smoothing coefficient calculating section 6 determines a change amount of the picture element of the target picture element changed by the smoothing processing. The change amount is expressed by a smoothing coefficient dSMT. As the smoothing coefficient dSMT, there are a coefficient dSMTc of the target picture element and a coefficient dSMTp of the partner picture element. If one of the coefficients dSMTc and dSMTp is a value other than 0, the other is 0.

The smoothing coefficient calculating section 6 determines whether there is a smoothing processing and determines smoothing coefficients dSMTc and dSMTp in accordance with a determination condition shown in FIG. 7. According to the determination condition shown in FIG. 7, when all of TM, AS and TCK are 1, it is determined that the target picture element is subjected to the smoothing processing, and a result data MS indicating this determination is set to 1. Further, the smoothing coefficients dSMTc and dSMTp at that time are determined in accordance with the template. Header information of a template specified as a representative template when the template matching is carried out is referred to, the parameter power, Sign, information of dSMTpos are obtained, and the smoothing coefficients dSMTc and dSMTp are determined based on these information sets. First, power of address 0 is referred to, and the change amount is determined. If the power is 0, the change amount is 0%, if the power is 2, the change amount is 20% and if the power is 4, the change amount is 40%. Next, the Sign of the address 1 is referred to and the increasing and decreasing direction is determined. If the Sign is 0, the symbol is “+” indicating the increasing direction, and if the Sign is 1, the symbol is “−” indicating the decreasing direction. Lastly, dSMTpos is the address 3 is referred to, and it is determined which one of the target picture element and the partner picture element should be a smoothing coefficient. If the dSMTpos is 0, the target picture element is the smoothing coefficient, and if the dSMTpos is 1, the partner picture element is the smoothing coefficient.

If the power is 2 and Sign is 0 and dSMTpos is 0 for example, it is determined that the smoothing coefficient dSMTc of the target picture element is +20 and the smoothing coefficient dSMTp of the partner picture element is 0. That is, the partner picture element is not subjected to the smoothing processing.

If at least one of TM, AS and TCK is 0, it is determined that the target picture element or the partner picture element is not subjected to the smoothing processing, a result data MS is set to 0, and both the smoothing coefficients dSMTc and dSMTp are set to 0.

The result data MS and the smoothing coefficients dSMT (dSMTc and dSMTp) are output to the thinning structure check section 7.

The thinning structure check section 7 detects a picture element to be subjected to the thinning processing. More specifically, it is determined whether there is a thin line structure in which “white”, “black” and “white” and picture element are arranged around the target picture element or the partner picture element, and there is such a thin line structure, a degree of the thinning processing is lowered or it is not subjected to the thinning processing.

When the target picture element is a “black” picture element (picture element in which picture element value is >SOB, black picture element, hereinafter), the thinning structure check section 7 determines that the structure is the thin line structure when picture elements located above, below, on the left and right of the target picture element is “white” picture elements (picture element in which picture element value <SOA, white picture element, hereinafter), and data TL indicating the determination result is set to 1. When the target picture element is white picture element and the template matches (when TM is 1), and when the partner picture element is black picture element and picture element adjacent to the black picture element (picture element located at a position opposed to the target picture element with the partner picture element interposed therebetween) is a white picture element, TL is also set to 1. Otherwise, it is determined that it is not a thin line structure, and TL is set to 0.

The thinning structure check section 7 sets strength STVL at the time of thinning processing. In a normal case (TL=0) as will be described later, STVL is set to be a reference value (e.g., 100), but when the structure if the thin line structure (TL=1), the STVL is set to a smaller value.
When TL=0, STVL=100, and when TL=1, STVL=20.

That is, when the structure is the thin line structure, STVL is set to a smaller value than that of the normal case, and the adjustment is made so that the thin degree is lowered. This is because that if the degree of the thinning processing in the thin line structure portion is set to the normal level, the thin line structure fades, and there is a possibility that the image quality is deteriorated. When TL is 1, STVL may be set to 0 so that thinning processing is not carried out.

The set result data TL and STVL are output to the thinning coefficient calculating section 8.

The thinning coefficient calculating section 8 determines whether a target picture element or a partner picture element is subjected to the thinning processing, and when it is determined that the thinning processing should be carried out, the thinning coefficient calculating section 8 calculates a thinning coefficient dST. The thinning coefficient dST indicates a change amount of a picture element value of a target picture element or a partner picture element. There are coefficient dSTc for the target picture element and a coefficient dSTp for the partner picture element as the thinning coefficients dST.

First, the thinning coefficient calculating section 8 determines whether a target picture element is a black edge (which is a black picture element and is a picture element corresponding to a boundary portion (edge) between a black picture element and a white picture element), and when the target picture element is the black edge, the thinning coefficient calculating section 8 determines that the thinning processing should be carried out, and sets the thinning coefficient dST.

It is determined whether the target picture element is the black edge in the following procedure. First, differences in a picture element value between the target picture element and picture elements located above, below and on the left side and right side thereof is obtained, and the maximum difference is determined as MAXDL. This MAXDL is compared with a threshold value EDGETH which is previously prepared for determining the black edge, and if MAXDL>EDGETH, it is determined that the target picture element is a black edge.

The thinning coefficient dST is set in the following manner based on the result data TM.

First, when TM is 0, i.e., when templates do not match and the target picture element is a black edge, dSTc is set to −STVL, and dSTp is set to 0. Since the target picture element is the black edge, the thinning processing is necessary, but since it does not match with the template, only the target picture element is subjected to the thinning processing. When the target picture element is not a black edge, since the thinning processing is unnecessary, dSTc is set to 0 and dSTp is set to 0.

When TM is 1, since the templates match, a structure for carrying out the thinning processing should surely be included. Hence, the header information in the representative template is referred to, and the thinning coefficient dST is determined. In the header information, dSTpos in address 4 is referred to, and if dSTpos is 0, since the target picture element is subjected to the thinning processing, both dSTc and dSTp are set to 0. If dSTpos is 1, dSTc is set to 0 and dSTp is set to −STVL to subject the partner picture element to the thinning processing.

The set thinning coefficient dST is output to the picture element value calculating section 9 together with the smoothing coefficient dSMT.

The picture element value calculating section 9 calculates a picture element value Cₒᵤₜ after a target picture element is subjected to the smoothing processing and/or the thinning processing based on an original picture element value Cᵢₙ of the target picture element, the smoothing coefficient dSMT, and the thinning coefficient dST.

First, the picture element value calculating section 9 determines whether the shift picture element is a target picture element of a partner picture element. The header information in the representative template is referred to, and determination is made such that if shiftpos in address 5 is 0, the shift picture element is a target picture element, and if shiftpos is 1, the shift picture element is a partner picture element. Further, it is determined whether the shift picture element is a black picture element, and a result data SPNF indicating the determination result is set. If the shift picture element is the black picture element, SPNF is set to 0, and the shift picture element is not the black picture element, SPNF is set to 1. SPNF=1 means that the element has a thin line structure of one dot thickness, and since the shift picture element is not the black picture element, a picture element value can not be shifted toward the shift picture element. The thinning processing for the shift picture element is discontinued, dST is forcibly set to 0, and thinning coefficient is corrected.

If the shift picture element is determined, a picture element value Cₒᵤₜ of a target picture element and a picture element value Pₒᵤₜ of a partner picture element after the smoothing processing and/or the thinning processing are calculated using the following equations 1 and 2.

Cₒᵤₜ=Cᵢₙ+dSTc+dSMTc×255 (1)

Pₒᵤₜ=Pᵢₙ+dSTp+dSMTp×255 (2)

In the equations 1 and 2, a change amount dST of a picture element value by the thinning processing and a change amount dSMT of a picture element value by the smoothing processing×255 are calculated, and a sum of these and the original picture element value is obtained.

Next, the picture element value calculating section 9 checks overflow or underflow of the calculated Cₒᵤₜ and Pₒᵤₜ, shifts the picture element values Cₒᵤₜ and Pₒᵤₜ of the target picture element or the partner picture element in accordance with a result of the check, and calculates the final picture element value Cₒᵤₜ and Pₒᵤₜ. This processing is carried out only when TM is 1, i.e., template matches. When TM is 0 and the templates do not match, Cₒᵤₜ is set to Cₒᵤₜ.

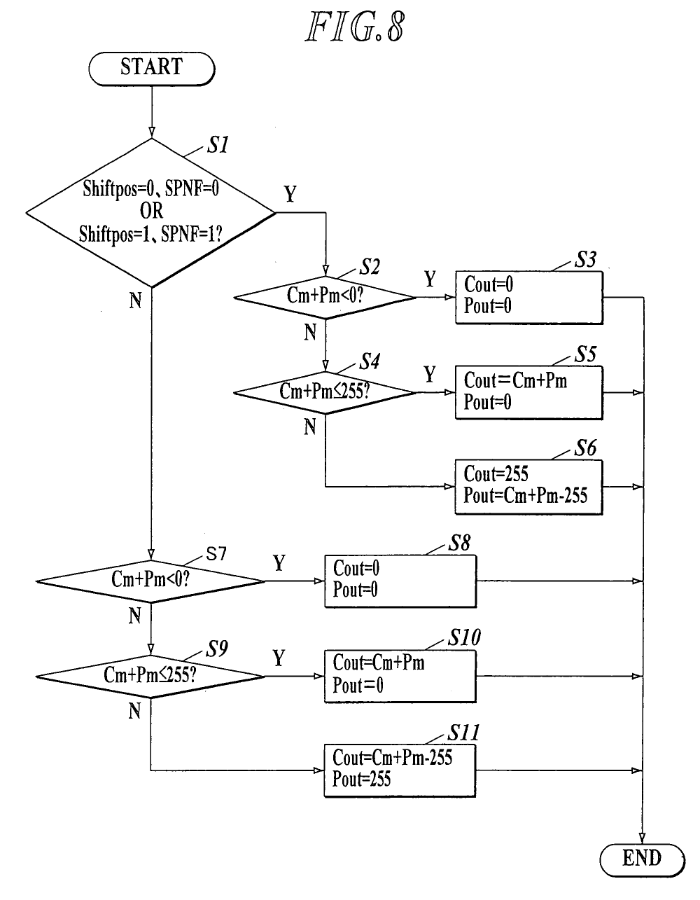

Calculation of the picture element values Cₒᵤₜ and Pₒᵤₜ will be explained with reference to FIG. 8.

As shown in FIG. 8, the picture element value calculating section 9 determines whether a picture element which finally shifts the picture element value becomes a target picture element or a partner picture element. This determination is made based on the SPNF and the shiftpos of the header information of the representative template. That is, when the shiftpos is 0 and the SPNF is 0 (step S1; Y), the shift picture element is a target picture element and is a black picture element. When the shiftpos is 1 and the SPNF is 1 (step S1; Y), the shift picture element is a picture element and is a white picture element. When these two conditions are satisfied, it is possible to determine that an element whose picture element value is finally shifted is a target picture element, and in a case other than this, it is possible to determine that the picture element value is shifted to the partner picture element.

First, a case in which it is determined that a picture element whose picture element value is finally shifted is the target picture element will be explained.

In this case, a sum of picture element values Cₒᵤₜ and Pₒᵤₜ of the target picture element and the partner picture element is evaluated. When Cₒᵤₜ+Pₒᵤₜ<0 (step S2; Y), Cₒᵤₜ=Pₒᵤₜ=0 (step S3). When 0≦Cₒᵤₜ+Pₒᵤₜ≦255, (step S2: N, S4; Y) , Cₒᵤₜ=Cₒᵤₜ+Pₒᵤₜ, Pₒᵤₜ=0 (step S5). When 255<Cₒᵤₜ+Pₒᵤₜ, (step S2; N, S4; N), Cₒᵤₜ=255, and Pₒᵤₜ=Cₒᵤₜ+Pₒᵤₜ−255 (step S6)

Next, a case in which a picture element whose picture element value is finally shifted is a partner picture element will be explained.

In this case, like the above case, a sum of the picture element values Cₒᵤₜ and Pₒᵤₜ of the target picture element and the partner picture element is evaluated. If Cₒᵤₜ+Pₒᵤₜ<0 (step S7; Y) , Cₒᵤₜ=Pₒᵤₜ=0 (step S8). If 0<Cₒᵤₜ+Pₒᵤₜ<255 (step S7; N, S9; Y) , Cₒᵤₜ=0 and Pₒᵤₜ=Cₒᵤₜ+Pₒᵤₜ (step S10). If 255<C, +Pₒᵤₜ (step S7; N, S9; N), Cₒᵤₜ=Cₒᵤₜ+Pₒᵤₜ−255, Pₒᵤₜ=255 (step S11).

If the picture element value is calculated, the finally obtained Cₒᵤₜ is output as a target picture element value after the thinning processing and the smoothing processing.

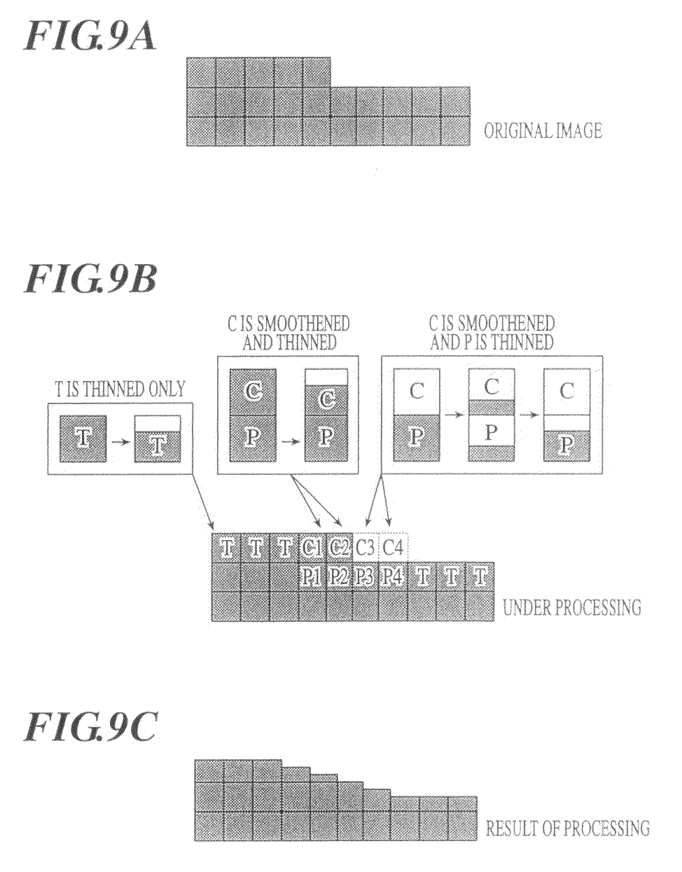

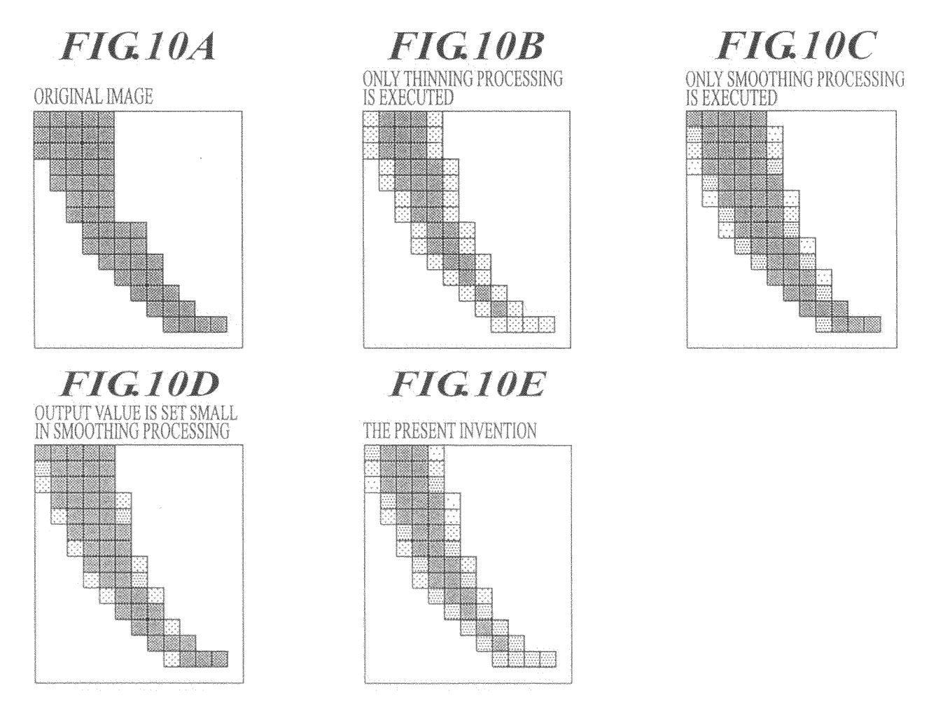

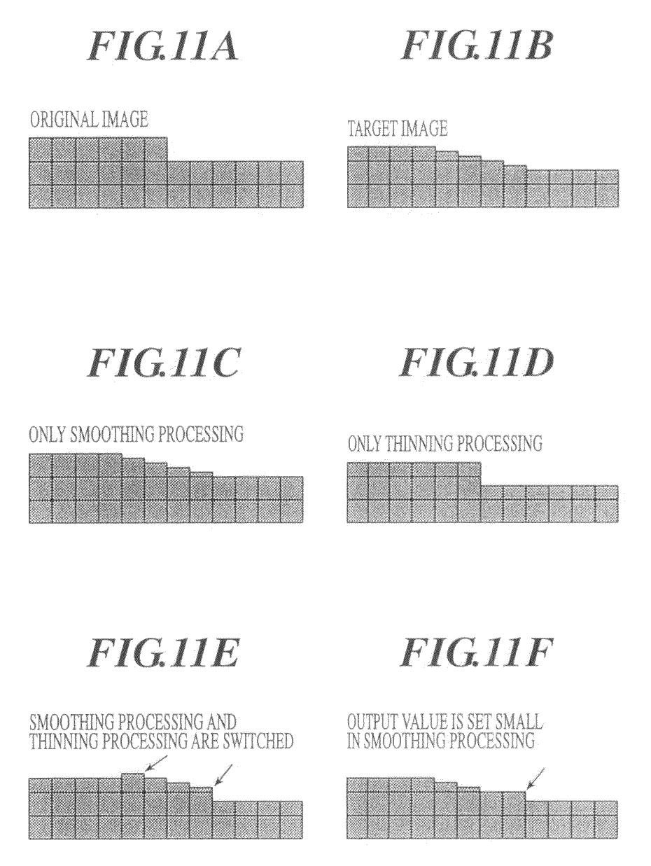

A result of processing by the image processing apparatus 10 will be explained with reference to FIGS. 9A to 9D.

FIG. 9A shows an original image including a solid character. When the solid character as shown in FIG. 9A is to be subjected to the processing, as a result of the template matching, if picture elements shown with Controller 1 to C4 near the edge of the solid character as show in FIG. 9B becomes a target picture element, it is determined that the template matches and picture elements shown with P1 to P4 are the partner picture elements. The picture element shown with T is a picture element whose template does not match when they become the target picture elements.

The template of the picture element shown with T does not match, and the smoothing coefficient dSMT is calculated as 0. Since the thin line structure is not established and the edge is a black edge, the thinning coefficient dST is calculated as −STVL. Therefore, only the thinning processing is carried out, and the picture element value Cₒᵤₜ is set to Cᵢₙ+dSTc×255.

The picture elements shown with Controller 1 and C2 are black edges and whose templates match, C1 and C2 are subjected to both the smoothing processing and thinning processing, and P1 and P2 which are partner picture elements thereof are not subjected to any processing. The picture elements C3 and C4 near the boundary of step are white picture elements and whose templates match. Therefore, only the smoothing processing is carried out, and P3 and P4 which are partner picture element thereof are black edges and thus, only the thinning processing is carried out. Then, the picture element value of the target picture elements C3 and C4 are shifted to the partner picture elements P3 and P4. As a result, the edge of the solid character is entirely thinned as shown in FIG. 9C, and step-like portions are smoothened.

According to the embodiment, an image structure to be subjected to the smoothing processing and/or the thinning processing is detected using the template. When the templates match, if the attribute of the target picture element is a character or a line, it is determined that the target picture element is subjected to the smoothing processing. It is determined that a picture element designated in the matched template (any one of the target picture element and the partner picture element) is subjected to the thinning processing. When templates do not match, it is determined that the target picture element is not subjected to the smoothing processing. When the target picture element is a black edge, it is determined that the thinning processing is carried out. When the target picture element is a white picture element, it is determined that the thinning processing is not carried out.

If execution/non-execution of the smoothing processing and the thinning processing are determined, their coefficient dMST and dST are determined. The smoothing coefficient dSMT uses a value which is previously defined in the template, and the thinning coefficient dST is determined in accordance with presence or absence of the thin line structure. Change amounts of picture element values in the target picture element and the partner picture element after the smoothing processing and/or the thinning processing are calculated by these coefficients. When templates do not match, a value obtained by changing a picture element value of the target picture element by the change amount is output as the target picture element value. If the templates match, picture element values of the target picture element and partner picture element are changed by the change amount, and a sum of the changed picture element values is obtained. When the sum is no in the range of 0 to 255, the picture element value of the target picture element or the partner picture element is shifted to a direction where it is designated as the shift picture element in the template of the target picture element or the partner picture element, and a target picture element value after the shifting is output.

That is, concerning an image portion which must be subjected to both the smoothing processing and thinning processing, two picture elements, i.e., the target picture element and the partner picture element are integrally processed. With this, the thinning and smoothing can be realized with excellent balance. As a result, the entire edge of a solid character can be thinned, and a smooth oblique line can be formed.

Concerning a picture element constituting the thin line structure, a degree of the thinning processing is lowered. Thus, deterioration of image quality including a case in which a thin line is lost due to the thinning processing can be prevented. A picture element having the thin line structure may not be subjected to the thinning processing. With this, deterioration in image quality can be avoided.

Effects of the invention will be explained will be explained with reference to FIGS. 10A to 10E.

In the case of an image of a solid character shown in FIG. 10A, it is output as it is, jaggies are generated and dot gain is generated, and a character is thickened. If an image is subjected to the thinning processing only, although a line can be thinned, jaggies can not be solved. If an image is subjected to the smoothing processing only on the other hand, it is not possible to prevent a character from being thickened as shown in FIG. 10C. When a method for reducing an output value in the smoothing processing is employed as in the conventional technique, although a line can slightly be thinned as shown in FIG. 10D, no little jaggies are generated.

According to this embodiment, however, it can be found that smoothing and thinning can be realized with excellent balance as shown in FIG. 10E.

According to a first aspect of the embodiment, there is provided an image processing apparatus comprising: a determining section to determine a target picture element and a partner picture element thereof in a subject image to be processed; a smoothing coefficient calculating section to obtain change amounts of picture element values in the target picture element and the partner picture element by subjecting the subject image to smoothing processing; a thinning coefficient calculating section for obtaining change amounts of picture element values in the target picture element and the partner picture element by subjecting the subject image to thinning processing; and a picture element value calculating section to calculate picture element values of the target picture element and the partner picture element processed by the smoothing processing and/or the thinning processing based on the change amounts of the picture element values by the smoothing processing and the change amounts of the picture element values by the thinning processing, and to determine an output picture element value of the target picture element processed by the smoothing processing and/or the thinning processing based on a sum of the calculated picture element values of the target picture element and partner picture element.

Preferably, the partner picture element is a picture element adjacent to the target picture element, and the determining section determines the target picture element and the partner picture element thereof in the subject image using a template in which a positional relation between the target picture element and the partner picture element is previously defined.

Preferably, the template is for detecting a structure to be subjected to the thinning processing and/or a structure to be subjected to the smoothing processing, the positional relation between the target picture element and the partner picture element is previously defined in accordance with the structure, and the determining section matches the template and the subject image with each other, so as to determine the target picture element and the partner picture element.

Preferably, the change amounts of picture element values of the target picture element and the partner picture element by the smoothing processing are previously defined in the template in accordance with the structure to be subjected to the smoothing processing, and the smoothing coefficient calculating section matches the template and the subject image with each other, and if the template and the subject image match with each other, the change amounts of the picture element values defined in the template are obtained as the change amounts of the picture element values of the target picture element and the partner picture element by the smoothing processing.

In the embodiment, it is possible to determine a picture element value of the target picture element from a sum of picture element values after the smoothing processing and/or the thinning processing of the target picture element and the partner picture element. That is, since the picture element value of the target picture element is determined based on processing results of both the smoothing processing and thinning processing, a processing result in which the smoothing processing and the thinning processing are associated with each other can be obtained. Since the picture element values of the two picture elements, i.e., the target picture element and the partner picture element can be operated, even if the picture element value of one of the picture elements is excessively increased or decreased, it can be compensated by the picture element value of the other picture element. Thus, it is possible to realize the smoothing and thinning with excellent balance without deteriorating the image quality.

Preferably, the image processing apparatus of the first aspect further comprises an attribution discriminating section to generate attribute data indicating attributes of all picture elements of the subject image, wherein the picture element value calculating section determines whether or not the target picture element constitutes a character or a line based on the produced attribute data, and calculates the output picture element value of the target picture element processed by the smoothing processing and/or the thinning processing only when the target picture element constitutes the character or line.

By doing so, only a picture element constituting a character or a line to be subjected to the smoothing processing and/or the thinning processing can be subjected to the smoothing processing and/or the thinning processing, and an image which is not suitable for the smoothing processing and/or the thinning processing such as a photograph is not subjected to such processing. With this, deterioration in image quality can be avoided.

Preferably, the image processing apparatus of the first aspect, further comprises a thin line structure detecting section to detect a thin line structure in the subject image, wherein the picture element value calculating section lowers a degree of the thinning processing lower than a normal value or does not perform the thinning processing when the target picture element constitutes the detected thin line structure.

By doing so, a degree of the thinning processing can be lowered or the thinning processing is not carried out. With this, it is possible to avoid such deterioration in image quality that a thin line is excessively thinned and faded.

According to a second aspect of the embodiment, there is provided an image processing method comprising the steps of: a determining step to determine a target picture element and a partner picture element thereof in a subject image to be processed; a smoothing coefficient calculating step to obtain change amounts of picture element values in the target picture element and the partner picture element by subjecting the subject image to smoothing processing; a thinning coefficient calculating step for obtaining a change amounts of picture element values in the target picture element and the partner picture element by subjecting the subject image to thinning processing; and a picture element value calculating step to calculate picture element values of the target picture element and the partner picture element processed by the smoothing processing and/or the thinning processing based on the change amount of the picture element value by the smoothing processing and the change amount of the picture element value by the thinning processing, and to determine an output picture element value of the target picture element processed by the smoothing processing and/or the thinning processing based on a sum of the calculated picture element values of the target picture element and partner picture element.

Preferably, the partner picture element is a picture element adjacent to the target picture element, and in the determining step, the target picture element and the partner picture element thereof in the subject image are determined using a template in which a positional relation between the target picture element and the partner picture element is previously defined.

Preferably, the template is for detecting a structure to be subjected to the thinning processing and/or a structure to be subjected to the smoothing processing, the positional relation between the target picture element and the partner picture element is previously defined in accordance with the structure, and in the determining step, the template and the subject image are matched with each other, so that the target picture element and the partner picture element is determined.

Preferably, the change amounts of picture element values of the target picture element and the partner picture element by the smoothing processing are previously defined in the template in accordance with the structure to be subjected to the smoothing processing, and in the smoothing coefficient calculating section, the template and the subject image are matched with each other, and if the template and the subject image match with each other, the change amounts of the picture element values defined in the template are obtained as the change amounts of the picture element value of the target picture element and the partner picture element by the smoothing processing.

In the embodiment, it is possible to determine a picture element value of the target picture element from a sum of picture element values after the smoothing processing and/or the thinning processing of the target picture element and the partner picture element. That is, since the picture element value of the target picture element is determined based on processing results of both the smoothing processing and thinning processing, a processing result in which the smoothing processing and the thinning processing are associated with each other can be obtained. Since the picture element values of the two picture elements, i.e., the target picture element and the partner picture element can be operated, even if the picture element value of one of the picture elements is excessively increased or decreased, it can be compensated by the picture element value of the other picture element. Thus, it is possible to realize the smoothing and thinning with excellent balance without deteriorating the image quality.

Preferably, the image processing method of the second aspect, further comprises an attribution discriminating step to generate attribute data indicating attributes of all picture elements of the subject image, wherein in the picture element value calculating step, whether or not the target picture element constitutes a character or a line is determined based on the produced attribute data, and the output picture element value of the target picture element processed by the smoothing processing and/or the thinning processing is calculated only when the target picture element constitutes the character or line.

By doing so, only a picture element constituting a character or a line to be subjected to the smoothing processing and/or the thinning processing can be subjected to the smoothing processing and/or the thinning processing, and an image which is not suitable for the smoothing processing and/or the thinning processing such as a photograph is not subjected to such processing. With this, deterioration in image quality can be avoided.

Preferably, the image processing method of the second aspect, further comprises a thin line structure detecting step to detect a thin line structure in the subject image, wherein in the picture element value calculating step, a degree of the thinning processing is lowered to be lower than a normal value or the thinning processing is not performed when the target picture element constitutes the detected thin line structure.

By doing so, a degree of the thinning processing can be lowered or the thinning processing is not carried out. With this, it is possible to avoid such deterioration in image quality that a thin line is excessively thinned and faded.

The present U.S. patent application claims a priority under the Paris Convention of Japanese patent application No. 2006-261181 filed in Japanese Patent Office on Sep. 26, 2006, which shall be a basis of correction of an incorrect translation.

What is claimed is:

1. An image processing apparatus comprising:
a determining section to determine a target picture element and a partner picture element thereof in a subject image to be processed;
a smoothing coefficient calculating section to obtain change amounts of picture element values in the target picture element and the partner picture element by subjecting the subject image to smoothing processing;
a thinning coefficient calculating section for obtaining change amounts of picture element values in the target picture element and the partner picture element by subjecting the subject image to thinning processing; and
a picture element value calculating section to calculate picture element values of the target picture element and the partner picture element processed by the smoothing processing and/or the thinning processing based on the change amounts of the picture element values by the smoothing processing and the change amounts of the picture element values by the thinning processing, and to determine an output picture element value of the target picture element processed by the smoothing processing and/or the thinning processing based on a sum of the calculated picture element values of the target picture element and partner picture element.

2. The image processing apparatus of claim 1, wherein the partner picture element is a picture element adjacent to the target picture element, and
the determining section determines the target picture element and the partner picture element thereof in the subject image using a template in which a positional relation between the target picture element and the partner picture element is previously defined.

3. The image processing apparatus of claim 2, wherein the template is for detecting a structure to be subjected to the thinning processing and/or a structure to be subjected to the smoothing processing, the positional relation between the target picture element and the partner picture element is previously defined in accordance with the structure, and
the determining section matches the template and the subject image with each other, so as to determine the target picture element and the partner picture element.

4. The image processing apparatus of claim 3, wherein the change amounts of picture element values of the target picture element and the partner picture element by the smoothing processing are previously defined in the template in accordance with the structure to be subjected to the smoothing processing, and
the smoothing coefficient calculating section matches the template and the subject image with each other, and if the template and the subject image match with each other, the change amounts of the picture element values defined in the template are obtained as the change amounts of the picture element values of the target picture element and the partner picture element by the smoothing processing.

5. The image processing apparatus of claim 1, further comprising an attribution discriminating section to generate attribute data indicating attributes of all picture elements of the subject image, wherein
the picture element value calculating section determines whether or not the target picture element constitutes a character or a line based on the produced attribute data, and calculates the output picture element value of the target picture element processed by the smoothing processing and/or the thinning processing only when the target picture element constitutes the character or line.

6. The image processing apparatus of claim 1, further comprising a thin line structure detecting section to detect a thin line structure in the subject image, wherein
the picture element value calculating section lowers a degree of the thinning processing lower than a normal value or does not perform the thinning processing when the target picture element constitutes the detected thin line structure.

7. An image processing method comprising the steps of:
a determining step to determine a target picture element and a partner picture element thereof in a subject image to be processed;
a smoothing coefficient calculating step to obtain change amounts of picture element values in the target picture element and the partner picture element by subjecting the subject image to smoothing processing;
a thinning coefficient calculating step for obtaining a change amounts of picture element values in the target picture element and the partner picture element by subjecting the subject image to thinning processing; and
a picture element value calculating step to calculate picture element values of the target picture element and the partner picture element processed by the smoothing processing and/or the thinning processing based on the change amount of the picture element value by the smoothing processing and the change amount of the picture element value by the thinning processing, and to determine an output picture element value of the target picture element processed by the smoothing processing and/or the thinning processing based on a sum of the calculated picture element values of the target picture element and partner picture element.

8. The image processing method of claim 7, wherein the partner picture element is a picture element adjacent to the target picture element, and
in the determining step, the target picture element and the partner picture element thereof in the subject image are determined using a template in which a positional relation between the target picture element and the partner picture element is previously defined.

9. The image processing apparatus of claim 8, wherein the template is for detecting a structure to be subjected to the thinning processing and/or a structure to be subjected to the smoothing processing, the positional relation between the target picture element and the partner picture element is previously defined in accordance with the structure, and
in the determining step, the template and the subject image are matched with each other, so that the target picture element and the partner picture element is determined.

10. The image processing apparatus of claim 9, wherein the change amounts of picture element values of the target picture element and the partner picture element by the smoothing processing are previously defined in the template in accordance with the structure to be subjected to the smoothing processing, and
in the smoothing coefficient calculating section, the template and the subject image are matched with each other, and if the template and the subject image match with each other, the change amounts of the picture element values defined in the template are obtained as the change amounts of the picture element value of the target picture element and the partner picture element by the smoothing processing.

11. The image processing method of claim 7, further comprising an attribution discriminating step to generate attribute data indicating attributes of all picture elements of the subject image, wherein
in the picture element value calculating step, whether or not the target picture element constitutes a character or a line is determined based on the produced attribute data, and the output picture element value of the target picture element processed by the smoothing processing and/or the thinning processing is calculated only when the target picture element constitutes the character or line.

12. The image processing method of claim 7, further comprising a thin line structure detecting step to detect a thin line structure in the subject image, wherein
in the picture element value calculating step, a degree of the thinning processing is lowered to be lower than a normal value or the thinning processing is not performed when the target picture element constitutes the detected thin line structure.
